(19) United States
(12) Patent Application Publication
(10) Pub. No.: US 2013/0193910 A1
(43) Pub. Date: Aug. 1, 2013

(54) ELECTRIC POWER TRANSMISSION DEVICE

(71) Applicant: Denso Corporation, Kariya-city (JP)

(72) Inventor: Yasukazu KITAMINE, Anjo-shi (JP)

(73) Assignee: DENSO CORPORATION, Kariya-city (JP)

(21) Appl. No.: 13/757,054

(22) Filed: Feb. 1, 2013

(30) Foreign Application Priority Data
Feb. 1, 2012 (JP) 2012-019467

(51) Int. Cl. H02J 7/00

(52) U.S. Cl. CPC H02J 7/0052
USPC 320/107

(57) ABSTRACT

An electric power transmission device transmits an electric power of a power supply to a battery. The electric power transmission device includes relay capacitor, power supply side switching element, and a battery side switching element. The relay capacitor is located between the power supply and the battery, and stores an electric power of the power supply. The power supply side switching element opens and closes a first electrical path between the power supply and the relay capacitor. The battery side switching element opens and closes a second electrical path between the relay capacitor and the battery. The power supply side switching element has a pair of ends in the first electrical path, one of which is connected to the relay capacitor and the other is not connected to another capacitor that is short-circuited with the relay capacitor when the power supply side switching element is closed.

### CROSS-REFERENCE TO RELATED APPLICATION

This application is based on and claims the benefit of priority from earlier Japanese Patent Application No. 2012-019467 filed Feb. 1, 2012, the description of which is incorporated herein by reference.

### BACKGROUND

1. Technical Field

The present invention relates to an electric power transmission device, which includes a relay capacitor and transmits an electric power from a power supply to a battery via the relay capacitor.

2. Related Art

This type of electric power transmission device is proposed in, for example, Japanese Patent No. 4655250. This device includes a rectifier unit, a step-up chopper circuit for power factor correction (PFC) control, and a relay capacitor. The rectifier unit rectifies an alternating current (AC) power supplied from a commercial power supply to thereby produce a direct current (DC) power, and outputs the DC power to the step-up chopper circuit. The step-up chopper circuit is connected to the rectifier section and steps up the DC power outputted from the rectifier section. This step-up chopper circuit is provided with an output capacitor which is connected to the relay capacitor via a power supply side switching element. The relay capacitor is connected to an on-board battery via a battery side switching element. This can supply the electric power of the commercial power supply to the on-board battery while isolating the on-board battery from the commercial power supply.

However, in the electric power transmission device described above, when the power supply side switching element, provided between the output capacitor of the step-up chopper circuit and the relay capacitor, is turned on, a large current called an inrush current is allowed to flow from the output capacitor to the relay capacitor. This may decrease a reliability of the switching element.

### SUMMARY

An exemplary embodiment provides an electric power transmission device that includes a relay capacitor and transmits an electric power, which is able to prevent a large current from flowing to the relay capacitor and to avoid decrease in its reliability.

According to an exemplary aspect of the present disclosure, there is provided an electric power transmission device for transmitting an electric power of a power supply to a battery, comprising: a relay capacitor located between the power supply and the battery, the relay capacitor storing an electric power of the power supply; a power supply side switching element configured to open and close a first electrical path between the power supply and the relay capacitor; and a battery side switching element configured to open and close a second electrical path between the relay capacitor and the battery that is an object to which the electric power is supplied from the power supply, the battery side switching element having a pair of ends in the second electrical path, one of which is connected to the relay capacitor, wherein: the power supply side switching element has a pair of ends in the first electrical path, one of which is connected to the relay capacitor and the other is not connected to an output capacitor that is short-circuited with the relay capacitor when the power supply side switching element is closed.

According to this configuration, the other of pair of ends of the power supply side switching element, which is not connected to the relay capacitor, is not connected to another capacitor (for example, an output capacitor provided at an output side of a step-up chopper circuit) that is short-circuited with the relay capacitor when the power supply side switching element is closed. Thus, even when the battery side switching element is closed, a large current such as inrush current does not flow from another capacitor such as an output capacitor provided at an output side of a step-up chopper circuit to the relay capacitor. This makes it possible to prevent a large current from flowing to the relay capacitor and to avoid decrease in its reliability.

### BRIEF DESCRIPTION OF THE DRAWINGS

In the accompanying drawings:

FIG. 1 is a diagram showing a system configuration of an electric power transmission device according to a first exemplary embodiment;

FIG. 2 is a timing chart showing an electric power transmission process in the electric power transmission device of FIG. 1;

FIG. 3 is a flow chart showing procedures of a process on a start of charging in the electric power transmission device of FIG. 1;

FIG. 4 is a diagram showing a system configuration of an electric power transmission device according to a second exemplary embodiment;

FIG. 5 is a timing chart showing an electric power transmission process in the electric power transmission device of FIG. 4;

FIG. 6 is a diagram showing a system configuration of an electric power transmission device according to a third exemplary embodiment; and

FIGS. 7A and 7B are diagrams showing a configuration of power supply side switching elements and battery side switching elements according to modifications of the first to third exemplary embodiments.

### DESCRIPTION OF EMBODIMENTS

Hereinafter, with reference to the accompanying drawings, exemplary embodiments of the present disclosure will be described. In these exemplary embodiments, an electric power transmission device of the present disclosure is applied to an on-board electric power transmission device mounted in a vehicle.

### First Exemplary Embodiment

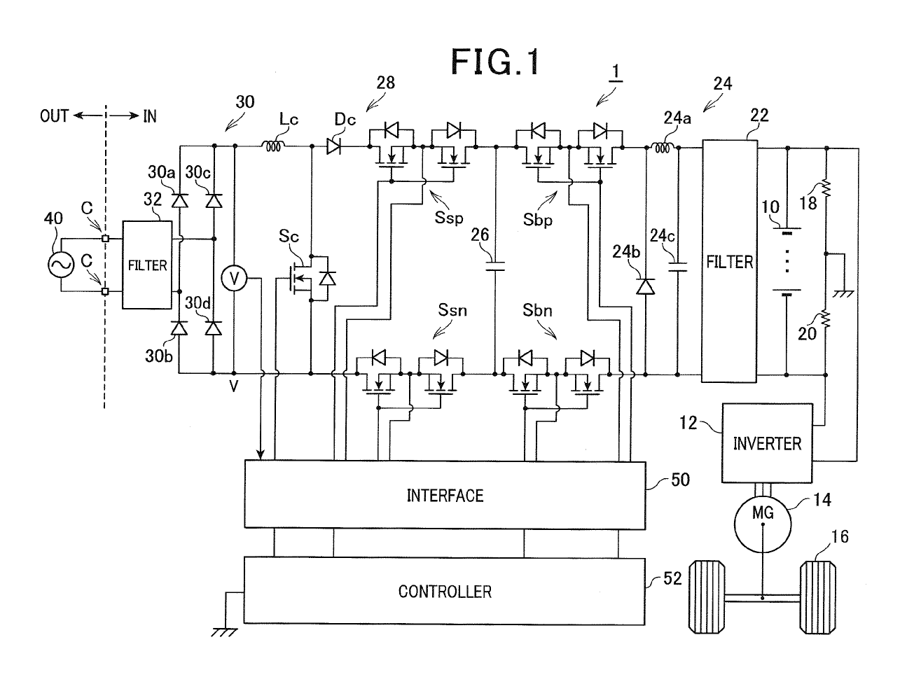

First, with reference to FIGS. 1 to 3, an on-board electric power transmission device according to a first exemplary embodiment is described below.

As shown in FIG. 1, an electric power transmission device 1 is mounted in a vehicle and supplies an electric power of a commercial power supply 40 which is an alternating current (AC) power supply outside the vehicle to a high-voltage battery 10 mounted in the vehicle.

The high-voltage battery 10 shown in FIG. 1 comprises storing means (battery unit) for storing electric energy for on-vehicle main machinery and has a terminal voltage of, for example, 100V or more. Specifically, the high-voltage battery 10 is connected to a rotary machine (i.e., a motor generator 14) as on-vehicle main machinery via an inverter 12. A rotor provided in the motor generator 14 is mechanically coupled to a driving wheel 16.

The high-voltage battery 10 is arranged so as to have higher impedance than a vehicle body. In the present exemplary embodiment, a median value between a positive electrode and a negative electrode of the high-voltage battery 10 is set to be an electric potential of the vehicle body. This can be achieved by setting an electric potential of a connection point between two resistors 18, 20, connected in parallel to the high-voltage battery 10, to the electric potential of the vehicle body. Here, the resistors 18, 20 have a large resistance which is able to much increase the impedance between the high-voltage battery 10 and the vehicle body.

In the present exemplary embodiment, the electric power transmission device 1 supplies an electric power of the commercial power supply 40 outside the vehicle to the high-voltage battery 10. The electric power transmission device 1 includes a power supply side filter 32, a full wave rectifier circuit 30, a step-up chopper circuit 28, power supply side switching elements (hereinafter referred to as “power supply side open/close elements”) Ssp, Ssn, a relay capacitor 26, battery side switching elements (hereinafter referred to as “battery side open/close elements”) Sbp, Sbn, a smoothing filter 24, a battery side filter 22, an interface 50, and a controller 52, between the commercial power supply 40 and the high-voltage battery 10.

As shown in FIG. 1, the full wave rectifier circuit 30 is connected to a connector C, which is connected to the commercial power supply 40, via the power supply side filter 32. This full wave rectifier circuit 30 includes a series connection of diodes 30a, 30b and a series connection of diodes 30e, 30d. A connection point between the diodes 30a, 30b and a connection point between the diodes 30c, 30d forms an input terminal. A cathode of the respective diodes 30a, 30c and an anode of the respective diodes 30b, 30d forms an output terminal.

In this configuration, the full wave rectifier circuit 30 rectifies an AC power supplied via the input terminal through the power supply side filter 32 from the commercial power supply 40 to thereby produce DC power, and outputs the DC power via the output terminal.

The step-up chopper circuit 28 is connected to the full wave rectifier circuit 30. This step-up chopper circuit 28 includes an inductor Lc, a chopper control switching element Sc, and a diode Dc. The inductor Lc stores an electric power outputted from the full wave rectifier circuit 30. The chopper control switching element Sc applies an output voltage of the full wave rectifier circuit 30 to both ends of the inductor Lc. The diode Dc outputs an electric power stored in the inductor Lc.

In this configuration, the step-up chopper circuit 28 steps up the DC power outputted from the full wave rectifier 30, and outputs the stepped up DC power.

The relay capacitor 26 is connected to the step-up chopper circuit 28 via the power supply side open/close elements Ssp, Ssn. The power supply side open/close elements Ssp, Ssn are configured to open and close a first electrical path between the commercial power supply 40 and the relay capacitor 26. The power supply side open/close elements Ssp, Ssn are closed and opened under electronic control. When the power supply side open/close elements Ssp, Ssn are opened, current does not flow in a direction from one to the other of both ends of a current flow path which is an opened/closed object as well as a direction from the other to one thereof.

In the present exemplary embodiment, the power supply side open/close elements Ssp, Ssn are configured by a pair of N-channel metal-oxide semiconductor field-effect transistors (MOSFETs) in which a short circuit is formed between each source of the pair thereof. The purpose of this short circuit is to make it easy to turn on and off the pair of N-channel MOSFETs. In general, N-channel MOSFET is turned on and off depending on an electric potential of its gate to its source. Then, a short circuit is formed between the sources of the pair of N-channel MOSFETs, thereby allowing the electric potential of these sources to be the same as each other, and making it possible to turn on and off the pair of N-channel MOSFETs by using a single voltage signal.

The relay capacitor 26 is connected to the smoothing filter 24 via the battery side open/close elements Sbp, Sbn. The battery side open/close elements Sbp, Sbn are configured to open and close a second electrical path between the relay capacitor 26 and the battery 10. The battery side open/close elements Sbp, Sbn are closed and opened under electronic control. When the battery side open/close elements Sbp, Sbn are opened, current does not flow in a direction from one to the other of both end portions of a current flow path which is an opened/closed object as well as a direction from the other to one thereof In the present exemplary embodiment, the battery side open/close elements Sbp, Sbn are configured by a pair of N-channel MOSFETs in which a short circuit is formed between each source of the pair thereof. The purpose of this short circuit is the same as that of the power supply side open/close elements Ssp, Ssn.

The smoothing filter 24 includes an energy storing inductor 24a, a diode which is connected in parallel to the relay capacitor 26, and a capacitor 24 which is connected in parallel to the relay capacitor via the energy storing inductor 24a. This smoothing filter 24 is a circuit that, regardless of intermittent closing operation of the battery side open/close elements Sbp, Sbn, prevents rapid change in current outputted to the side of the high-voltage battery 10.

The smoothing filter 24 is connected to the high voltage battery 10 via the battery side filter 22. This battery side filter 22 is configured by including, for example, a common-mode choke coil, X capacitor, and a Y capacitor.

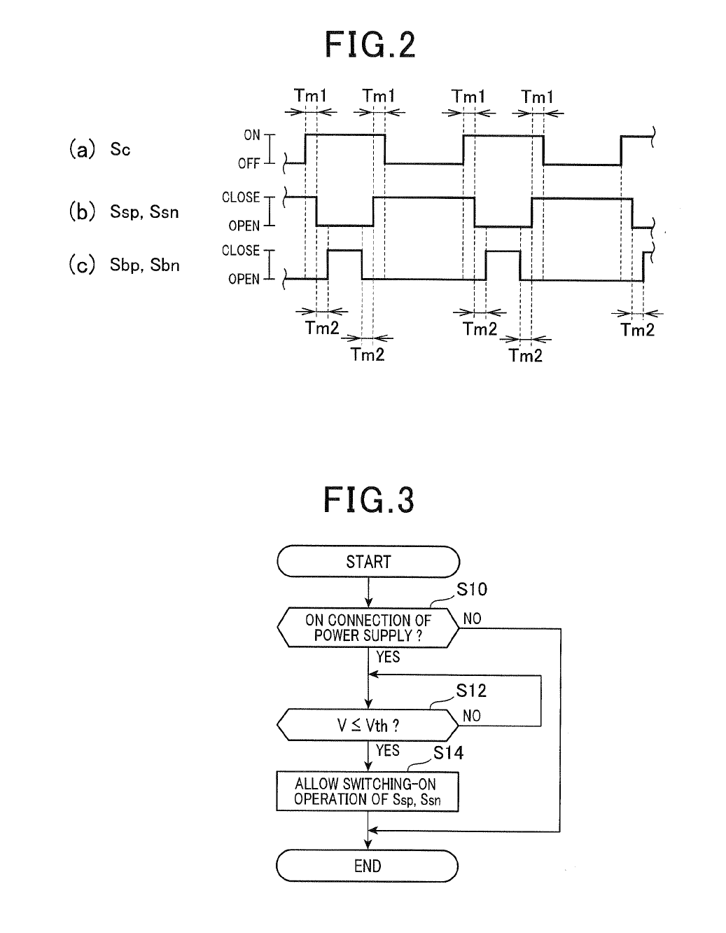

As shown in FIG. 2, the power supply side open/close elements Ssp, Ssn and the battery side open/close elements Sbp, Sbn are operated by the controller 52 via the interface 50. In the controller 52, an electric potential different from a negative electrode of the high-voltage battery 10 is set to a reference electric potential. In the present exemplary embodiment, an electric potential of a vehicle body is set to the electric reference potential. The interface 50 is configured by including isolation communication means for transmitting signals while isolating the side of the controller 52 from the side of the high-voltage battery 10. For example, a pulse transformer may be used as one example of the isolation communication means.

In the present exemplary embodiment, the step-up chopper circuit 28 is not provided with an output capacitor provided on the output side thereof. In other words, the relay capacitor 26 is used as a substitute for a capacitor (output capacitor) provided at an output side of a well-known step-up chopper circuit. Thus, there is no capacitor which is short-circuited with the relay capacitor 26 via the power supply side open/close elements Ssp, Ssn when the power supply side open/close elements Ssp, Ssn are closed. This is because, with such a short-circuited output capacitor (i.e., output capacitor), a large current called an inrush current may flow from this capacitor to the relay capacitor 26 due to a closing operation of the power supply side open/close elements Ssp, Ssn. The purpose of the above configuration with no output capacitor of the step-up chopper circuit is to avoid such a situation.

Beside this, in order to avoid the above situation where a large current may flow, the following techniques (i) and (ii) may be also considered:

(i) decreasing a capacitance of the relay capacitor 26; and

(ii) increasing an electric resistance between the step-up chopper circuit 28 and the relay capacitor 26 such as on-resistance of the power supply side open/close elements Ssp, Ssn.

However, the technique (i) is likely to excessively decrease an electric power which can be transmitted during one period of open/close of the power supply side open/close elements Ssp, Ssn. This leads to a decrease in a transmission rate of the electric power. To cope with this situation, a technique for increasing an open/close rate of the power supply side open/close elements Ssp, Ssn may be further considered. However, this technique is likely to increase a switching loss of the power supply side open/close elements Ssp, Ssn.

On the other hand, the technique (ii) is likely to increase electric power loss and to decrease electric power transmission efficiency.

In contrast, in the present exemplary embodiment, the relay capacitor 26 is used as a substitute for a capacitor on the output side of the step-up chopper circuit 28. Thus, the inductor Lc can restrict a change rate of current flows into the relay capacitor 26 due to close-operation of the power supply side open/close elements Ssp, Ssn. Specifically, when the chopper control switching element Sc is switched on, current flows in a loop path (first loop path) including the full wave rectifier circuit 30, the inductor Lc, and the chopper control switching element Sc, and then, energy is stored in the inductor Lc. When the chopper control switching element Sc is then switched off, current flows in a loop path (second loop path) including the full wave rectifier circuit 30, the inductor Lc, and the relay capacitor 26. In this case, an increasing rate of current flowing into to the relay capacitor 26 is restricted by inductance of the inductor Lc. This can decrease an electrical resistance of an electrical path from a cathode side of the diode Dc to the relay capacitor 26, or increase a capacitance of the relay capacitor 26 to some extent.

In this case, if the power supply side open/close elements Ssp, Ssn are opened when the chopper control switching element Sc is changed from a switching-on condition into an switching-off condition, a voltage of the anode side of the diode Dc may be excessively increased.

To cope with this, in the present exemplary embodiment, the power supply side open/close elements Ssp, Ssn and the battery side open/close elements Sbp, Sbn are operated in such a manner as shown in FIG. 2. That is, the power supply side open/close elements are closed before the chopper control switching clement Sc is switched off, and the power supply side open/close elements Ssp, Ssn are opened after the chopper control switching element Sc is switched on.

Here, a time period Tm1, between a timing at which the power supply side open/close elements Ssp, Ssn are closed and a timing at which the chopper control switching element Sc is switched off, is set to be same as a time period Tm1 between a timing at which the chopper control switching element Sc is switched on and a timing at which the power supply side open/close elements Ssp, Ssn are opened. These time periods Tm1 are set to be equal to or larger than a time required for the chopper control switching element Sc and the power supply side open/close elements Ssp, Ssn to be switched on/off.

On the other hand, the battery side open/close elements Sbp, Sbn are operated so as to prevent a situation where an isolation (insulation) between the side of the high-voltage battery 10 and the side of the commercial power supply 40 is not kept. This is because both of the power supply side open/close elements Ssp, Ssn and the battery side open/close elements Sbp, Sbn are closed. In other words, the battery side open/close elements Sbp, Sbn are closed while the power supply side open/close elements Ssp, Ssn are opened. This can be achieved by such an operation that the power supply side open/close elements Ssp, Ssn are opened before the battery side open/close elements Sbp, Sbn are closed, and the power supply side open/close elements Sbp, Sbn are closed after the battery side open/close elements Sbp, Sbn are opened.

Here, a time period Tm2, between a timing at which the power supply side open/close elements Ssp, Ssn are opened and a timing of at which the battery side open/close elements Sbp, Sbn are closed, is set to be same as a time period Tm2 between a timing at which the battery side open/close elements Sbp, Sbn are opened and a timing at which the the power supply side open/close elements Ssp, Ssn are closed. These time periods Tm2 are set to be equal to or larger than a time required for the battery side open/close elements Sbp, Sbn and the power supply side open/close elements Ssp, Ssn to be closed and opened. This is so called a dead time setting.

The purpose of the switching-on/off operation of the chopper control switching element Sc is to use the set-up chopper circuit 28 as a power factor correction (PFC) circuit. Then, a time ratio of a switching-on period to one switching-on/off period is variably operated depending on a phase of an output current of the full wave rectifier circuit 30. In this regard, a switching frequency itself may be set to be variable.

FIG. 3 shows a procedure of processes on a start of an electric power transmission. These processes are repeatedly performed by the controller 52 at a predetermined period. In the present exemplary embodiment, the controller 52 operates as switching (open/close) control means and synchronizing means configured by these processes.

In a series of processes, first, at step S10, the controller 52 judges whether or not the commercial power supply 40 is connected to the connector C. As a result, if judged that there is the time (YES) at step S10, at step S12, the controller 52 judges whether or not an output voltage V of the full wave rectifier circuit 30 is equal to or smaller than a prescribed voltage Vth. The purpose of this process is to judge whether or not there is a zero-cross timing of an output current of the full wave rectifier circuit 30. Then, if an affirmative judgment (YES) is obtained at step S12, the controller 52 permits the power supply side open/close elements Ssp, Ssn to close at step S14.

If a negative judgment (NO) is obtained at step S10 or a process of step S14 is completed, the series of processes is temporarily terminated.

These processes can avoid a situation where inrush current flows in the relay capacitor 26. Thus, there is no need for providing a pre-charge high impedance path between the full wave rectifier circuit 30 and the relay capacitor 26.

As described above, according to a configuration of the present exemplary embodiment, an electric power of the commercial power supply 40 can be transmitted to the high-voltage battery 10, while isolating the high-voltage battery 10 from the commercial power supply 40. Thus, for example, even when there is a member for making contact between an output terminal on a low voltage side (an anode of the diodes 30b, 30d) and the vehicle body, it is possible to prevent occurrence of a situation where the high-voltage battery 10 is charged and discharged via this member.

In addition, in the present exemplary embodiment, the power supply side open/close elements Ssp, Ssn and the battery side open/close elements Sbp, Sbn are provided at both of an positive electrode side and a negative electrode side, and are designed such that current is prevent from flowing in any directions, thereby largely contributing to an improvement of isolation performance between the high-voltage battery 10 and the commercial power supply 40.

Further, it is possible to easily reduce a loss due to electric power transmission compared to a case where a power conversion circuit with a transformer is used. This is because there is no power loss due to the transformer. In particular, it is possible to more easily reduce this loss because techniques for reducing on-resistance of MOSFETs have advanced in recent years and then a conduction loss of the power supply side open/close elements Ssp, Ssn and the battery side open/close elements Sbp, Sbn can be reduced. Thus, a cooling device for the electric power transmission can be configured by an air-cooling system, not a water-cooling system which is usually used.

Here, a period capable of outputting energy charged in the relay capacitor 26 into the side of the smoothing filter 24 is limited to a period during which the battery side open/close elements Sbp, Sbn are closed. However, when the battery side open/close elements Sbp, Sbn are opened, energy stored in the energy storing inductor 24a can flow in a loop path including the energy storing inductor 24a and the diode 24b. Thus, even while the battery side open/close elements Sbp, Sbn are opened, energy stored in the energy storing inductor 24a can be outputted to the high-voltage battery 10. Here, it is preferable that an inductance of the inductor 24a is set such that, if there is a certain amount of electric power transmission, current flowing in the inductor 24a gradually decreases but does not reduce to zero while the battery side open/close elements Sbp, Sbn are opened.

### Second Exemplary Embodiment

Next, a second exemplary embodiment is described, focusing on the differences from the first exemplary embodiment.

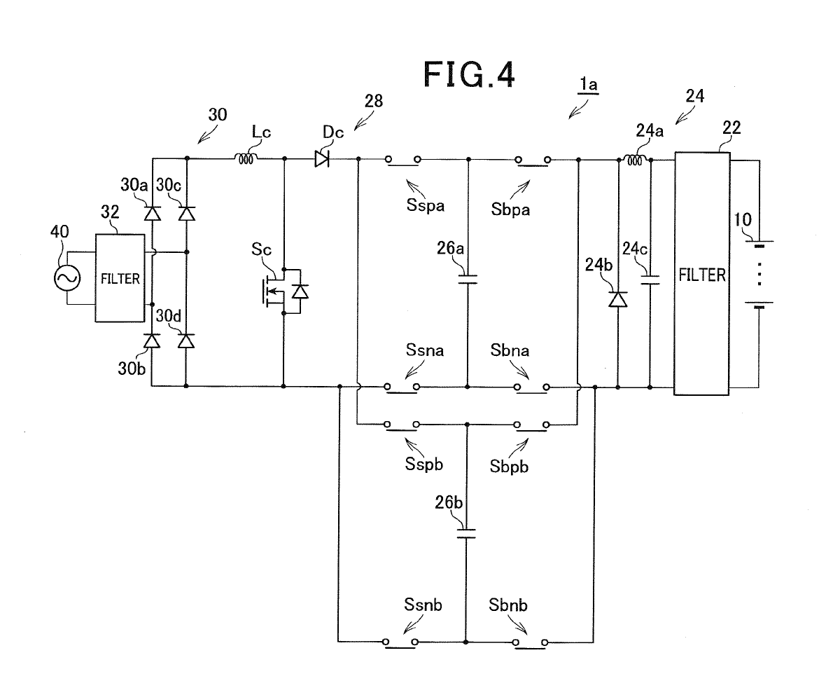

FIG. 4 shows a configuration of an electric power transmission device 1a according to the present exemplary embodiment. In FIG. 4, the components identical with or similar to those in the first exemplary embodiment are given the same reference numerals for the sake of omitting unnecessary explanation.

As shown in FIG. 4, the electric power transmission device 1a of the present exemplary embodiment is provided with two sets of power supply side open/close elements, relay capacitors, and battery side open/close elements. Specifically, as shown in FIG. 4, this electric power transmission device la includes: (i) a first set of power supply side open/close elements Sspa, Ssna, a relay capacitor 26a, and battery side open/close elements Sbpa, Sbna; and (ii) a second set of power supply side open/close elements Sspb, Ssnb, a relay capacitor 26b, and battery side open/close elements Sbpb, Sbnb).

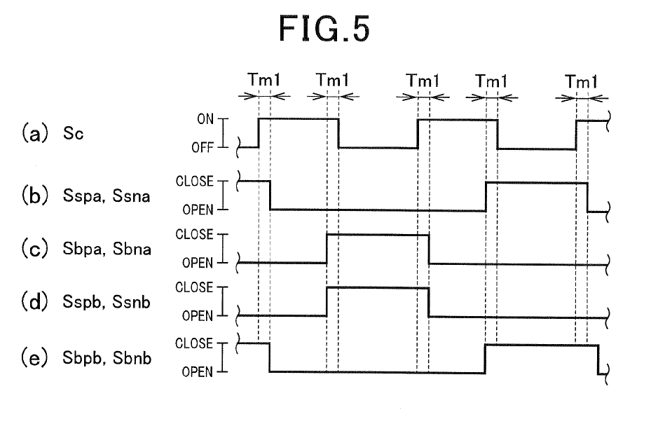

FIG. 5 shows an electric power transmission process according to the present exemplary embodiment.

As shown in FIG. 5, a period during which the chopper control switching element Sc is switched off is configured so as to alternately include a period during which the power supply side open/close elements Sspa, Ssna are closed and a period during which the power supply side open/close elements Sspb, Ssnb are closed. Thus, a period during which the power supply side open/close elements Sspa, Ssna are closed becomes longer, and then, a period during which the battery side open/close elements Sbpa, Sbna are closed becomes longer. Similary, a period during which the power supply side open/close elements Sspb, Ssnb are opened becomes longer, and then, a period during which the battery side open/close elements Sbpb, Sbnb are closed becomes longer. This can lengthen a time during which the apparatus is capable of outputting energy charged in relay capacitors 26a, 26b into the side of the smoothing filter 24. Thus, a transmission rate of electric power can be improved.

Here, a period during which the battery side open/close elements Sbpa, Sbna (the battery side open/close elements Sbpb, Sbnb) are closed may be set to an arbitrary long time within a period during which the power supply side open/close elements Sspa, Ssna (the power supply side open/close elements Sspb, Ssnb) are opened. In the present exemplary embodiment, the period during which the battery side open/close elements Sbpa, Sbna are in the closed condition is set to be equal to the period during which the power supply side open/close elements Sspb, Ssnb are closed. In addition, the period during which the battery side open/close elements Sbpb, Sbnb are closed is set to be equal to the period during which the power supply side open/close elements Sspa, Ssna are closed. The purpose of these setting is to simplify a configuration by matching an operation signal for the battery side open/close elements Sbpa, Sbna and an operation signal for the power supply side open/close elements Sspb, Ssnb as well as by matching an operation signal for the battery side open/close elements Sbpb, Sbnb and an operation signal for the power supply side open/close elements Sspa, Ssna.

### Third Exemplary Embodiment

Next, a third exemplary embodiment is described, focusing on the differences from the first exemplary embodiment.

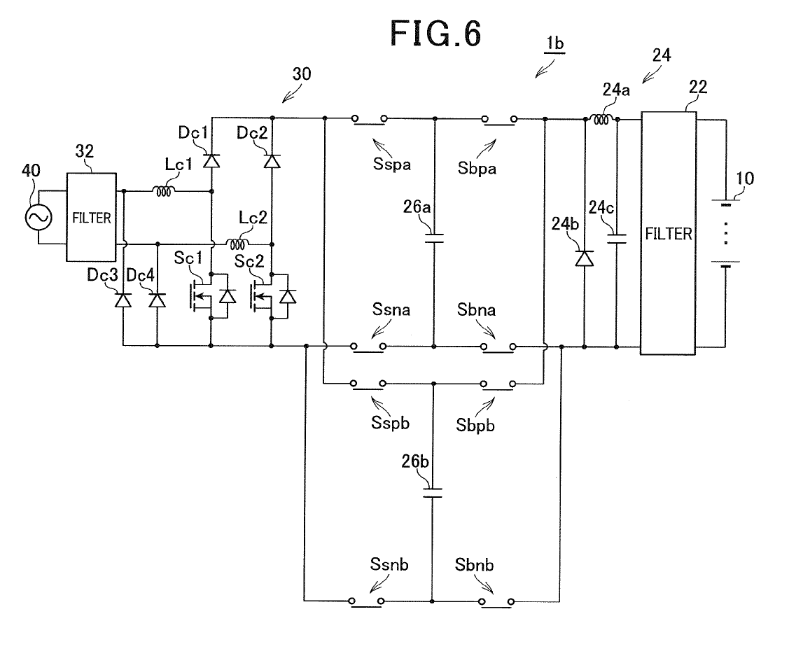

FIG. 6 shows a configuration of an electric power transmission device 1b according to the present exemplary embodiment. In FIG. 6, the components identical with or similar to those in the first exemplary embodiment are given the same reference numerals for the sake of omitting unnecessary explanation.

In the an electric power transmission device 1b of the present exemplary embodiment, the full wave rectifier circuit 30 and the step-up chopper circuit 28 share the diodes Dc1, Dc2. Specifically, as shown in FIG. 6, the step-up chopper circuit 28 includes two sets of (a) a series connection of a diode and a chopper control switching element and (b) an inductor connected to a connection point thereof: (1) one set is: (a1) a series connection of a diode Dc1 and a chopper control switching clement Sc1; and (b1) an inductor Lc1 connected to a connection point thereof; and (2) the other set is: (a2) a series connection of a diode Dc2 and a chopper control switching element Sc2; and (b2) an inductor Lc2 connected to a connection point thereof. The full wave rectifier circuit 30 is configured by the diodes Dc1, Dc2 and the chopper control switching elements Sc1, Sc2. These inductors Lc1, Lc2 are connected to diodes Dc3, Dc4 for noise reduction.

The above configuration which is also called a bridgeless boost is applied in the present exemplary embodiment. Compared to the configuration shown in FIG. 1, this can make it possible to reduce the number of elements (semiconductor devices) by one. In these elements, a loss is caused when current flows from the commercial power supply 40 to the relay capacitors 26a, 26b. Thus, an efficiency of transmission of electric power can be improved.

### (Modifications)

The first to third exemplary embodiments described above may be implemented in modifications as set forth below.

### (Power Supply Side/Battery Side Open/Close Elements)

In the first to third exemplary embodiments described above, the power supply side open/close elements and the battery side open/close elements are configured by a pair of N-channel MOSFETs whose sources are short-circuited with each other, but are not limited to this in the present disclosure. For example, they may be configured by a pair of N-channel MOSFETs whose drains are short-circuited with each other. In this case, the electric power transmission device may be provided with a driving circuit for driving the pair of N-channel MOSFETs. The driving circuit may be configured individually for each of the pair of N-channel MOSFETs. As substitute for the N-channel MOSFETs, P-channel MOSFETs may be used as MOSFETs.

In the first to third exemplary embodiments described above, the pair of MOSFETs is provided with blocking means for blocking bidirectional flow of current when the power supply side open/close elements and the battery side open/close elements are electronically operated to be changed into the opened condition. The blocking means is not limited to this configuration using the pair of MOSFETs.

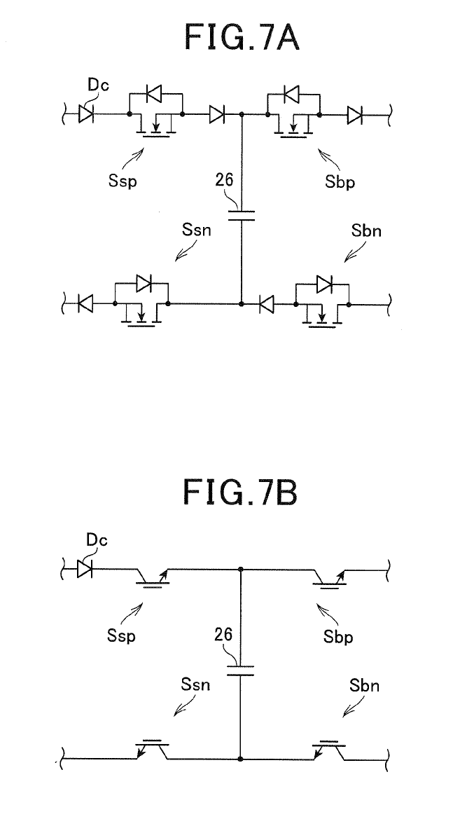

For example, as shown in FIG. 7A, power supply side open/close elements Ss# (#=p, n) and battery side open/close elements Sb# (#=p, n) are configured by a series connection of a single MOSFET and a diode. In the series connection, a forward direction of the diode is opposite to that of a parasitic diode of the MOSFET. The power supply side open/close element Ssp may include no diode, and the diode Dc of the step-up chopper circuit 28 may be used as a substitute for this.

For example, as shown FIG. 7B, power supply side open/close elements Ss# (#=p, n) and battery side open/close elements Sb# (#=p, n) may be configured by using an element that allows current to flow only in one direction when they are electronically operated to be changed into be the closed condition. As one example of this element, FIG. 7B shows an insulated gate bipolar transistor (IGBT). The IGBT may be connected in anti-parallel to a first diode and may be further connected in series to a second diode whose forward direction is opposite to that of the first diode.

For example, in the configuration of the first exemplary embodiment (see FIG. 1) described above, even when the power supply side open/close elements Ss# (#=p, n) and the battery side open/close elements Sb# (#=p, n) acting as the blocking means describe above are configured by using the single MOSFET, it is possible to easily reduce heat generation due to electric power transmission, compared to the configuration using the transformer. Such an effect is also obtained by a configuration provided with (i) only one of the power supply side open/close elements Ssp, Ssn or (ii) only one of the battery side open/close elements Sbp, Sbn in the first exemplary embodiment.

### (Inductor)

In the first exemplary embodiment (see FIG. 1) described above, the inductor Lc may be connected between the chopper control switching element Sc and the anode of the diodes 30b, 30d.

In the exemplary embodiments described above, the inductor Lc configuring the step-up chopper circuit 28 is used. As a substitute for this, an inductor configuring a step-up/down circuit may be used. This step-up/down circuit may include: (i) a first series connection of a pair of switching elements connected in parallel to the full wave rectifier circuit 30; (ii) a second series connection of a pair of switching elements connected in parallel to the relay capacitor 26; and (iii) an inductor connecting a connection point of the first series connection and a connection point of second series connection.

### (Switching Control Means of Controller)

In the first to third exemplary embodiments described above, the switching control means of the controller 52 is configured to control the chopper control switching element Sc, the power supply side open/close elements Ss# (#=p, n) and the battery side open/close elements Sb# (#=p, n) such that: (i) the power supply side open/close elements Ss# are closed (i.e., a close/open command for the power supply side open/close elements Ss# is change into a close command) before the chopper control switching element Sc is switched off (i.e., a switching-on/off command for the chopper control switching element Sc is changed into a switching-off command); and (ii) the power supply side open/close elements Ss# are opened (i.e., the close/open command for the power supply side open/close elements SO is change into an open command) after the chopper control switching element Sc is switched on (i.e., the switching-on/off command for the chopper control switching element Sc is changed into a switching-on command). The switching control means is not limited to this.

For example, when a transmission time of a command (switching-on/off command) for changing a switching condition of the power supply side open/close elements Ss# is shorter than that of the chopper control switching element Sc, a switching of the switching-off command for the chopper control switching element Sc may be synchronized with a switching of the close command for the power supply side open/close elements Ss#.

In the second exemplary embodiments (see FIG. 5) described above, a switching-on/off of the power supply side open/close elements Ss#a (#=p, n) is synchronized with a switching-on/off of the battery side open/close elements Sb#b (#=p, n), and a switching-on/off of the power supply side open/close elements Ss#b (#=p, n) is synchronized with a switching-on/off of the battery side open/close elements Sb#a (#=p, n). For example, a switching-on period of the battery side open/close elements Sb#a may include a switching-on period of the power supply side open/close elements Ss#b. This makes it possible to certainly establish electrical continuity between the smoothing filter 24 and either of the relay capacitors 26a, 26b. On the contrary, the switching-on period of the power supply side open/close elements Ss#b may include the switching-on period of the battery side open/close elements Sb#a.

(Plurality of Sets of Relay Capacitors and Power supply Side/Battery Side Open/Close Elements)

The plurality of sets of the relay capacitors, the power supply side open/close elements, and the battery side open/close elements are not limited to two sets, but may be three or more sets which are different in switching-on/off period form one another. In this case, these settings include the power supply side open/close elements Ss#, which is in the closed condition during the off-period of the shopper control switching element Sc. This makes it possible to reduce a switching loss per unit time of the power supply side open/close elements Ss#.

### (Rectifier or Rectifying Means)

In the third exemplary embodiment (see FIG. 6) described above, the diodes Dc3, Dc4 may be omitted. In the first exemplary embodiments (see FIG. 1) described above, a half wave rectifier circuit may be used as a substitute for the full wave rectifier circuit 30.

### (Synchronizing Means of Controller)

In the synchronizing means of the controller 52 in the first exemplary embodiments (see FIG. 1) described above, a zero-cross timing of an output current of the full wave rectifier circuit 30 (rectifying means) is used as a timing when an output voltage V of the full wave rectifier circuit 30 is equal to or smaller than a prescribed voltage Vth, but is not limited to this. For example, in the controller 52, this zero-cross timing may be used as a timing when an output voltage of the rectifying means is turned from a declining trend into a rising trend.

The electric power transmission device may further include a pre-charging circuit etc. In this case, the synchronizing means is not essential and may be omitted.

### (Energy Storing Inductor)

When an output current to the high-voltage battery 10 is allowed to be in a discontinuous manner, the energy storing inductor 24a may be omitted. When this output current is fully smoothed by, for example, the smoothing capacitor 24c, the energy storing inductor 24a may be also omitted. These conditions may be achieved by, for example, a configuration capable of reliably establishing electrical continuity between the smoothing filter 24 and either of the relay capacitors 26a, 26b in the second exemplary embodiment (see FIG. 4).

### (Flow Restriction Element)

The flow restriction element is not limited to the diode 24b of the smoothing filter 24, but may be, for example, a switching element for synchronous rectification, i.e., a switching element which is switched on in synchronization with a period during which the battery side open/close elements Sb# are opened.

### (Battery Unit)

The battery unit is not limited to the high-voltage battery 10 of storing electric energy of a rotary machine as on-vehicle main machinery, but may be, for example, a battery provided in a house.

### (Others)

The battery side filter 22 and the power supply side filter 32 is not essential and may be omitted.

The present disclosure may be embodied in several other forms without departing from the spirit thereof. The embodiments and modifications described so far are therefore intended to be only illustrative and not restrictive, since the scope of the disclosure is defined by the appended claims rather than by the description preceding them. All changes that fall within the metes and bounds of the claims, or equivalents of such metes and bounds, are therefore intended to be embraced by the claims.

What is claimed is:

1. An electric power transmission device for transmitting an electric power of a power supply to a battery, comprising:
a relay capacitor located between the power supply and the battery, the relay capacitor storing an electric power of the power supply;
a power supply side switching element configured to open and close a first electrical path between the power supply and the relay capacitor; and
a battery side switching element configured to open and close a second electrical path between the relay capacitor and the battery that is an object to which the electric power is supplied from the power supply, the battery side switching element having a pair of ends in the second electrical path, one of which is connected to the relay capacitor,
wherein:
the power supply side switching element has a pair of ends in the first electrical path, one of which is connected to the relay capacitor and the other is not connected to another capacitor that is short-circuited with the relay capacitor when the power supply side switching element is closed.

2. The electric power transmission device according to claim 1, further comprising:
an inductor connected between the power supply and the power supply side switching element, the inductor storing an electric power of the power supply; and
a chopper control switching element connected between the power supply and the power supply side switching element,
wherein:
the chopper control switching element is switched on and off such that a first loop path and a second loop path are formed:
in the first loop path, current flowing from the power supply to the inductor is gradually increased;
in the second loop path, current flowing in the inductor is gradually decreased; and
the relay capacitor is included in the second loop path and is not included in the first loop path.

3. The electric power transmission device according to claim 2, wherein:
the relay capacitor is connected in parallel to the chopper control switching element via the power supply side switching element; and
the inductor is connected between the power supply and one of a pair of ends of a current flow path of the chopper control switching element.

4. The electric power transmission device according to claim 3, further comprising:
switching control means for controlling the power supply side switching element, the battery side switching element, and the chopper control switching element such that the battery side switching element is closed if, while the chopper control switching element is switched off, (i) the battery side switching element is closed and (ii) electrical continuity is not established between the other of the pair of ends of the power supply side switching element, which is not connected to the relay capacitor, and the other of the pair of ends of the battery side switching element which is not connected to the relay capacitor.

5. The electric power transmission device according to claim 4, wherein:
the switching control means is configured to control the power supply side switching element, the battery side switching element, and the chopper control switching element such that (i) the battery side switching element is closed before the chopper control switching element is switched off and (ii) the battery side switching element is opened after the chopper control switching element is switched on.

6. The electric power transmission device according to claim 5, wherein:
the relay capacitor, the power supply side switching element, and the battery side switching element are configured by a plurality of sets of relay capacitors, power supply side switching elements, and battery side switching elements: and
the switching control means is further configured to control the plurality of sets of relay capacitors, power supply side switching elements, and battery side switching elements such that: (i) in at least two sets of the plurality of sets, an open/close timing of each of the power supply side switching elements is set to be differentiated from each other; and (ii) in a first set of the at least two sets in which the power supply side switching element is not closed, the battery side switching element is closed while the chopper control switching element is switched off.

7. The electric power transmission device according to claim 6, wherein:
the power supply is an alternating current (AC) power supply; and
the electric power transmission device is provided with a rectifier (30) between the AC power supply and the power supply side switching element, the rectifier rectifying an AC power of the AC power supply.

8. The electric power transmission device according to claim 7, wherein:
at least part of the rectifier is connected between the power supply side switching element and the inductor.

9. The electric power transmission device according to claim 8, further comprising:
synchronizing means for synchronizing a switching timing, at which the power supply side switching element is closed under the condition that a charged voltage of the relay capacitor is equal to or smaller than a prescribed value, at a zero-cross timing of an output current of the rectifier.

10. The electric power transmission device according to claim 9, further comprising:
an energy storing inductor; and
a flow restriction element configured to close a loop path capable of outputting energy of the energy storing inductor to the battery when the battery side switching element is closed.

11. The electric power transmission device according to claim 10, wherein:
the power supply side switching element and the battery side switching element are provided for the respective ends of the relay capacitor.

12. The electric power transmission device according to claim 11, wherein:
the power supply side switching element and the battery side switching element are configured to block both bidirectional flows of current in a flow path when they are opened under electronic control.

13. The electric power transmission device according to claim 12, wherein:
the electric power transmission device is mounted in a vehicle provided with a rotary machine as on-vehicle main machinery; and
the battery is configured by means for storing electric energy of the rotary machine.

14. The electric power transmission device according to claim 2, further comprising:
open/close control means for controlling the power supply side switching element, the battery side switching element, and the chopper control switching element such that the battery side switching element is closed if, while the chopper control switching element is switched off, (i) the battery side switching element is closed and (ii) electrical continuity is not established between the other of the pair of ends of the power supply side switching element, which is not connected to the relay capacitor, and the other of the pair of ends of the battery side switching element which is not connected to the relay capacitor.

15. The electric power transmission device according to claim 14, wherein:
the open/close control means is configured to control the power supply side switching element, the battery side switching element, and the chopper control switching element such that (i) the battery side switching clement is closed before the chopper control switching element is switched off and (ii) the battery side switching element is opened after the chopper control switching clement is switched on.

16. The electric power transmission device according to claim 15, wherein:
the relay capacitor, the power supply side switching element, and the battery side switching element are configured by a plurality of sets of relay capacitors, power supply side switching elements, and battery side switching elements: and
the open/close control means is further configured to control the plurality of sets of relay capacitors, power supply side switching elements, and battery side switching elements such that: (i) in at least two sets of the plurality of sets, an open/close timing of each of the power supply side switching elements is set to be differentiated from each other; and (ii) in a first set of the at least two sets in which the power supply side switching element is not closed, the battery side switching element is closed while the chopper control switching element is switched off

17. The electric power transmission device according to claim 16, wherein:
the power supply is an alternating current (AC) power supply; and
the electric power transmission device is provided with a rectifier between the AC power supply and the power supply side switching element, the rectifier rectifying an AC power of the AC power supply.

18. The electric power transmission device according to claim 17, wherein:
at least part of the rectifier is connected between the power supply side switching element and the inductor.

19. The electric power transmission device according to claim 18, further comprising:
synchronizing means for synchronizing a switching timing, at which the power supply side switching element is closed under the condition that a charged voltage of the relay capacitor is equal to or smaller than a prescribed value, at a zero-cross timing of an output current of the rectifier.

20. The electric power transmission device according to claim 19, further comprising:
an energy storing inductor; and
a flow restriction element configured to close a loop path capable of outputting energy of the energy storing inductor to the battery when the battery side switching element is closed.
